(19) United States
(12) Patent Application Publication
(10) Pub. No.: US 2008/0152459 A1
(43) Pub. Date: Jun. 26, 2008

(54) Anchor bolt cap and method of use

(76) Inventors: Norman L. Tooman, Bakersfield, CA (US); Joseph W. Bruce, Bakersfield, CA (US)

Correspondence Address: Charlette M. Crissman;Klein, DeNatale, Goldner, 2nd Floor, 4550 California Avenue, Bakersfield, CA, 93309, US

(21) Appl. No.: 12/004,825

(22) Filed: Dec. 21, 2007

Related U.S. Application Data
(60) Provisional application No. 60/876,692, filed on Dec. 21, 2006.

(51) Int. Cl. F16B 37/14

(52) U.S. Cl. 411/372.5

(57) ABSTRACT

The anchor bolt cap for placement over an anchor bolt and nut assembly has an anchor bolt nut enclosure with bottom and top sides, a tubular anchor bolt enclosure member with bottom and top ends, and an end cap with a closed top side and an open bottom side. The distance between the tubular anchor bolt enclosure member bottom and top ends is variable. The tubular anchor bolt enclosure member top end is connected to the end cap open bottom side, and the bottom end is connected to the anchor bolt nut enclosure top side. The anchor bolt nut enclosure bottom side can have a groove containing an o-ring, or a bottom flange member with a groove containing an o-ring. The anchor bolt nut enclosure top side can have a flange. The connection means can be thermal or chemical welding, or mating threads. The method of using the anchor bolt cap comprises determining the length of the tubular anchor bolt enclosure member, cutting the tubular anchor bolt enclosure member, attaching an end of the tubular anchor bolt enclosure member to an anchor bolt nut enclosure and another end of the tubular anchor bolt enclosure member to an end cap, and using a slide hammer to place the anchor bolt nut enclosure onto an anchor bolt nut. The anchor bolt cap may also be removed using a slide hammer.

### CROSS-REFERENCE TO RELATED APPLICATIONS

This application claims the benefit of U.S. Provisional Application No. 60/876,692, filed Dec. 21, 2006, which is hereby incorporated by reference.

### FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION BY REFERENCE OF MATERIAL SUBMITTED ON A COMPACT DISK

Not Applicable

### BACKGROUND OF THE INVENTION

1. Field of the Invention

The disclosed device relates to an anchor bolt cap and method of use for use in connection with anchoring towers or other vertical structures that are subject to high torque loading. The anchor bolt cap and method of use has particular utility in connection with the anchoring of towers or other vertical structures into bedrock. The bolts used to anchor these structures into bedrock are drilled into the bedrock and this installation method provides a higher torque load-bearing capacity than is provided by a cast concrete foundation. Due to the increased torque load-bearing capacity, the tower that can be supported by a bedrock installation is larger then the tower that can be supported by a cast concrete foundation. Additionally, these larger bolts will often be used in conjunction with the smaller bolts to support a flange that covers a larger surface area than is possible with the smaller bolts alone.

Unlike the anchor bolts used in a cast concrete foundation, the anchor bolts supporting the tower in a bedrock installation can vary in the length of the anchor bolt that protrudes above ground, and therefore after the anchor bolt is pre-stressed against the flange. The differences in length that result from this installation type make it difficult to utilize an anchor bolt cap having a fixed length. The disclosed anchor bolt caps allow for compensation for the differences in exposed length of the anchor bolts above the flange, and allows for the protection of the anchor bolts and nuts from the elements.

Additionally, as the anchor bolt caps may occasionally need removed to monitor the corrosion status of the anchor bolt and nut, and to confirm that the nut has maintained the correct tension against the flange, the disclosed anchor bolt cap and method of use provides for removal and replacement of the anchor bolt cap for monitoring purposes.

2. Description of the Prior Art

The use of bolt and anchor caps is known. For example, U.S. Pat. No. 6,808,350 to Tooman et al. discloses an anchor bolt cap and method of use. However, the Tooman '350 patent does not have the structure as the presently disclosed device.

U.S. Pat. No. 4,557,654 to Masuda et al. discloses a cover of a nut in engagement with a bolt, that fits tightly over a nut and bolt. However, the Masuda '654 patent does not provide the necessary variability of length.

Similarly, U.S. Pat. No. 3,471,158 to Solins discloses a composite moisture proofing device for sealing and retaining control devices within a panel. However, the Solins '158 patent does not provide the upper cap structure to facilitate removal.

Additionally, U.S. Pat. No. 4,907,929 to Johnston, Jr. discloses a bolt and nut cover that tightly covers a bolt and nut. However, the Johnston, Jr. '929 patent also does not provide for ease of removal.

The above-described devices do not describe the disclosed anchor bolt cap and method of use; therefore, a need exists for an improved anchor bolt cap and method of use that addresses the above stated problem.

### SUMMARY OF THE INVENTION

The disclosed device meets the need described above. The general purpose of the disclosed device, which will be described subsequently in greater detail, is to provide an anchor bolt cap and method of use that allows for a variable height anchor bolt cap with ease of placement and removal.

To attain this, the disclosed device essentially comprises an anchor bolt nut enclosure with a bottom side sized to fit over the anchor bolt nut and a top side having an aperture sized to fit over the anchor bolt. There is a tubular anchor bolt enclosure member with a bottom end and a top end. The distance between the bottom end and the top end is variable to compensate for the differing lengths of anchor bolts that result from the use of bedrock anchor bolts. The length that the anchor bolt and nut assembly protrudes above the flange following installation and pre-tensioning determines the length of the tubular anchor bolt enclosure member. The general range that the anchor bolt and nut assembly protrudes above the flange following installation is from 12 inches to 36 inches above the nut. This range is the protruding lengths encountered thus far and is not intended to limit the disclosed device to that range. The tubular anchor bolt enclosure member bottom end connects to the anchor bolt nut enclosure top side. There is an end cap having a closed top side and an open bottom side. The open bottom side connects to the tubular anchor bolt enclosure member top end.

The anchor bolt nut enclosure bottom side can have a groove, and there can be an o-ring placed in the groove. The anchor bolt nut enclosure bottom side can have a bottom flange member, and the anchor bolt nut enclosure bottom flange member can have a groove, and there can be an o-ring placed in the groove. The anchor bolt nut enclosure top side can have a flange member sized to encompass the diameter of the anchor bolt.

The connections can be accomplished through thermal or chemical welding, or mating threads on the tubular anchor bolt enclosure member ends that match threads on the anchor bolt nut enclosure top side and the open bottom side of the end cap. There are, of course, additional features of the disclosed device that will be described hereinafter and which will form the subject matter of the claims attached.

The method of using the anchor bolt cap for placement over an anchor bolt and nut assembly comprises determining the length of the tubular anchor bolt enclosure member and cutting the tubular anchor bolt enclosure member to size. The length is determined by the length required to cover the portion of the anchor bolt that protrudes above the flange following pre-tensioning of the anchor bolt and nut assembly. The enclosure member has first and second ends adapted for connection to the other parts of the anchor bolt nut cap. The first end of the tubular anchor bolt enclosure member is attached to the top side of the anchor bolt nut enclosure, and the second end of the tubular anchor bolt enclosure member is attached to the open bottom side of the end cap. The anchor bolt nut enclosure fits within the open bottom side of the end cap. The anchor bolt cap may be placed onto the anchor bolt and nut assembly using a slide hammer, by placing a slide hammer around the tubular anchor bolt enclosure member and driving the hammer downward to seat the anchor bolt cap against the anchor bolt nut. The slide hammer impacts against the anchor bolt nut enclosure top side. The anchor bolt nut enclosure bottom side will contact the flange, and in this manner protect the anchor bolt and nut assembly from the elements.

The anchor bolt cap may be removed using a slide hammer by placing the slide hammer around the tubular anchor bolt enclosure member and driving the hammer upward to dislodge the anchor bolt cap. The slide hammer impacts against the end cap.

Thus has been broadly outlined the more important features of the anchor bolt cap and method of use so that the detailed description thereof that follows may be better understood and in order that the present contribution to the art may be better appreciated.

Numerous objects, features and advantages of the anchor bolt cap and method of use will be readily apparent to those of ordinary skill in the art upon reading the following detailed description of the anchor bolt cap and method of use when taken in conjunction with the accompanying drawings. In this respect, before explaining the anchor bolt cap and method of use in detail, it is to be understood that the invention is not limited in its application to the details of construction and arrangements of the components set forth in the following description or illustration. The invention is capable of other embodiments and of being practiced and carried out in various ways. It is also to be understood that the phraseology and terminology employed herein are for purposes of description and should not be regarded as limiting.

Those skilled in the art will appreciate that the conception upon which this disclosure is based may readily be utilized as a basis for the design of other structures, methods and systems for carrying out the several purposes of the anchor bolt cap and method of use. It is therefore important that the claims be regarded as including such equivalent constructions insofar as they do not depart from the spirit and scope of the disclosed device.

These together with additional objects of the anchor bolt cap and method of use, along with various novel features that characterize the invention are particularly pointed out in the claims forming a part of this disclosure. For better understanding of the anchor bolt cap and method of use, refer to the accompanying drawings and description.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a bottom plan view of the anchor bolt cap.

FIG. 2 is a top plan view of the anchor bolt cap.

FIG. 3 is a side view of the anchor bolt cap.

FIG. 4 is a perspective view of the anchor bolt cap.

FIG. 5 is an exploded view of the anchor bolt cap, showing the nut enclosure member, the bolt enclosure member and the end cap.

FIG. 6 is a cross sectional view of the anchor bolt cap, showing the nut enclosure member, the bolt enclosure member and the end cap.

FIG. 7 is an exploded cross sectional view of the anchor bolt cap, showing the nut enclosure member, the bolt enclosure member and the end cap.

FIG. 8 is a typical installation using an anchor bolt and nut assembly.

FIG. 9 is a typical installation using an anchor bolt and nut assembly.

The same reference numbers refer to the same parts throughout the various figures.

### DETAILED DESCRIPTION OF THE EMBODIMENT

Referring now to the drawings, the anchor bolt cap of the disclosed device is shown and generally designated by the reference numeral 10.

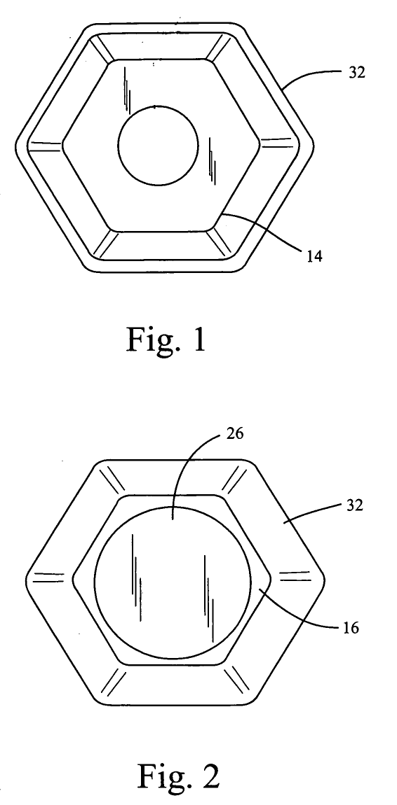

In FIG. 1, the anchor bolt cap is seen from underneath, and shows the anchor bolt nut enclosure bottom side 14, and the anchor bolt nut enclosure bottom flange member 32.

FIG. 2 shows the anchor bolt nut enclosure top side 16, the end cap top side 26, and the anchor bolt nut enclosure bottom flange member 32.

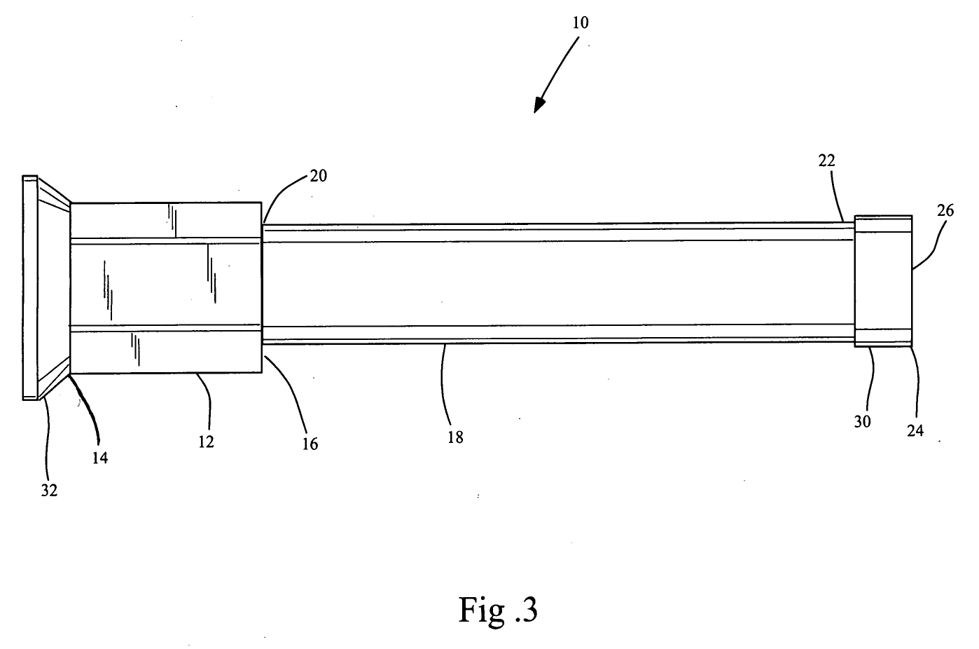

FIG. 3 is a side view of the anchor bolt cap 10, and shows the anchor bolt nut enclosure 12, the anchor bolt nut enclosure bottom side 14, and the anchor bolt nut enclosure top side 16. The tubular anchor bolt enclosure member 18 has an anchor bolt enclosure member bottom end 20 and an anchor bolt enclosure member top end 22. The tubular anchor bolt enclosure member bottom end 20 has a connection means adapted for connection to the anchor bolt nut enclosure top side 16. The distance between the anchor bolt enclosure member bottom end 20 and the anchor bolt enclosure member top end 22 is variable to compensate for the differing lengths of anchor bolts protruding above the anchor bolt and nut assembly. There is an end cap 24 having an end cap top side 26 and an end cap open bottom side 30. The open bottom side 30 has a connection means adapted for connection to the tubular anchor bolt enclosure member top end 22. The anchor bolt nut enclosure bottom side 14 can have an anchor bolt nut enclosure bottom flange member 32.

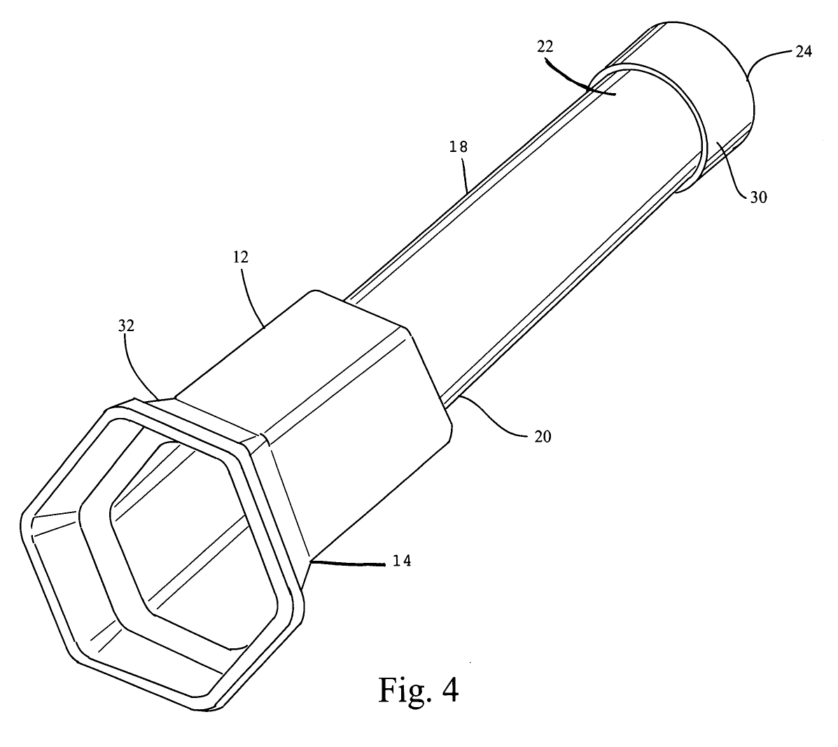

FIG. 4 is a perspective view of the anchor bolt cap, and shows the anchor bolt nut enclosure 12 and the anchor bolt nut enclosure bottom side 14. The tubular anchor bolt enclosure member 18 has an anchor bolt enclosure member bottom end 20 and an anchor bolt enclosure member top end 22. The distance between the anchor bolt enclosure member bottom end 20 and the anchor bolt enclosure member top end 22 can vary to allow for coverage of the differing lengths of anchor bolts found in typical installations. The end cap 24 and end cap open bottom side 30 can be seen, as can the anchor bolt nut enclosure bottom flange member 32. The open bottom side 30 has a connection means adapted for connection to the tubular anchor bolt enclosure member top end 22.

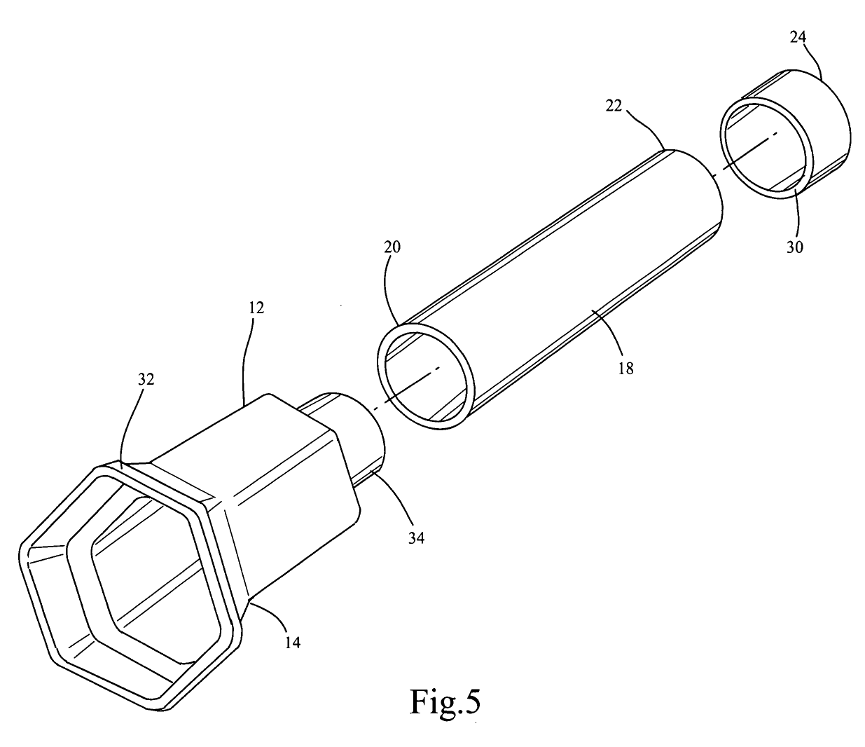

FIG. 5 shows the anchor bolt nut enclosure 12 and the anchor bolt nut enclosure bottom side 14. The tubular anchor bolt enclosure member 18 has an anchor bolt enclosure member bottom end 20 and an anchor bolt enclosure member top end 22. The distance can vary between the anchor bolt enclosure member bottom end 20 and the anchor bolt enclosure member top end 22 to accommodate the lengths of anchor bolts that protrude above the flange in a typical installation. The end cap 24 has an end cap open bottom side 30. The open bottom side 30 has a connection means for connection to the tubular anchor bolt enclosure member top end 22. The anchor bolt nut enclosure bottom side 14 can have an anchor bolt nut enclosure bottom flange member 32, and there can be a groove for placement and retention of a gasket, o-ring or similar.

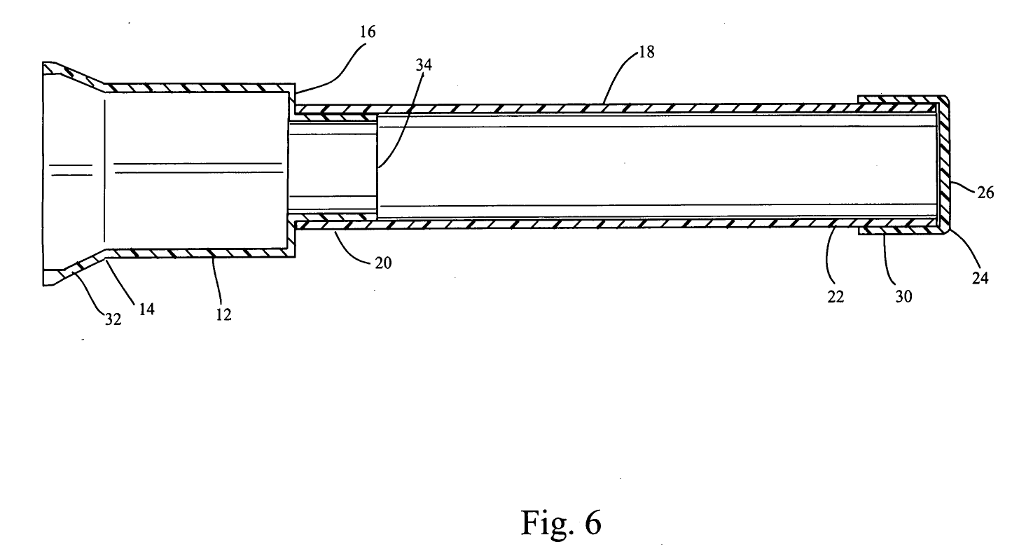

FIG. 6 is a cross sectional view of the anchor bolt and shows the anchor bolt nut enclosure 12, the anchor bolt nut enclosure bottom side 14, and the anchor bolt nut enclosure top side 16. The tubular anchor bolt enclosure member 18 has an anchor bolt enclosure member bottom end 20 and an anchor bolt enclosure member top end 22. The tubular anchor bolt enclosure member bottom end 20 has a connection means adapted for connection to the anchor bolt nut enclosure top side 16. There is an end cap 24 having an end cap top side 26, and an end cap open bottom side 30. The open bottom side 30 has a connection means adapted for connection to the tubular anchor bolt enclosure member top end 22. The anchor bolt nut enclosure bottom side 14 can have an anchor bolt nut enclosure bottom flange member 32, and there can be a groove for placement and retention of a gasket, o-ring or similar.

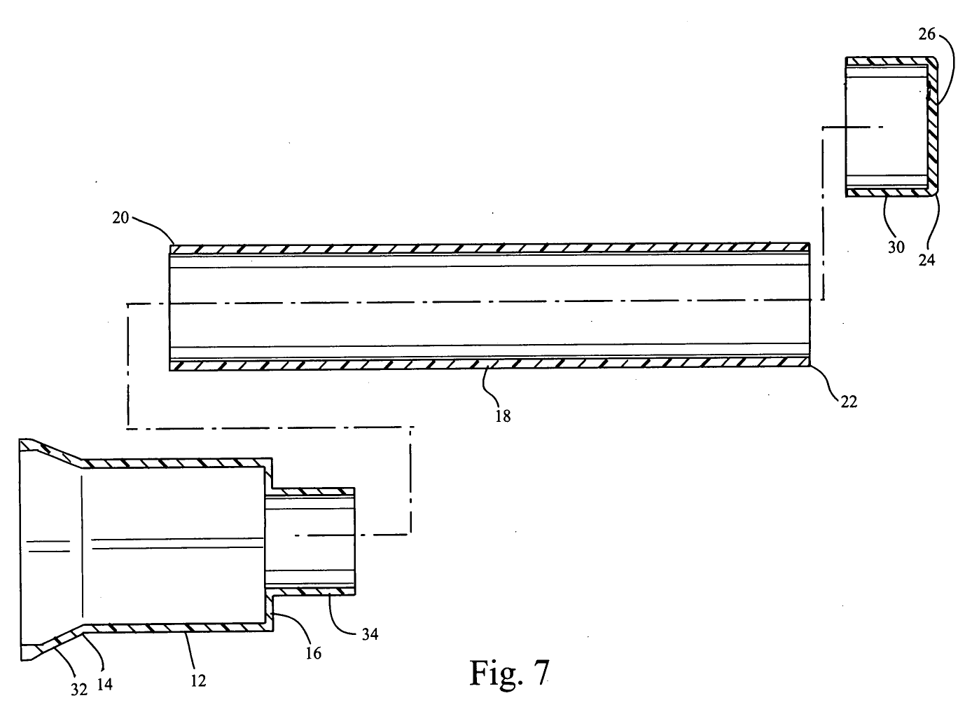

FIG. 7 is an exploded cross sectional view, showing the anchor bolt nut enclosure 12, the anchor bolt nut enclosure bottom side 14, and the anchor bolt nut enclosure top side 16. The tubular anchor bolt enclosure member 18 has an anchor bolt enclosure member bottom end 20, and an anchor bolt enclosure member top end 22. The tubular anchor bolt enclosure member bottom end 20 has a connection means adapted for connection to the anchor bolt nut enclosure top side 16. The distance between the anchor bolt enclosure member bottom end 20 and the anchor bolt enclosure member top end 22 is variable to allow for coverage of different protruding lengths of the anchor bolts used in bedrock installations. There is an end cap 24 having an end cap top side 26, and an end cap open bottom side 30. The open bottom side 30 has a connection means adapted for connection to the tubular anchor bolt enclosure member top end 22. The anchor bolt nut enclosure bottom side 14 can have an anchor bolt nut enclosure bottom flange member 32, and there can be a groove for placement and retention of a gasket, o-ring or similar.

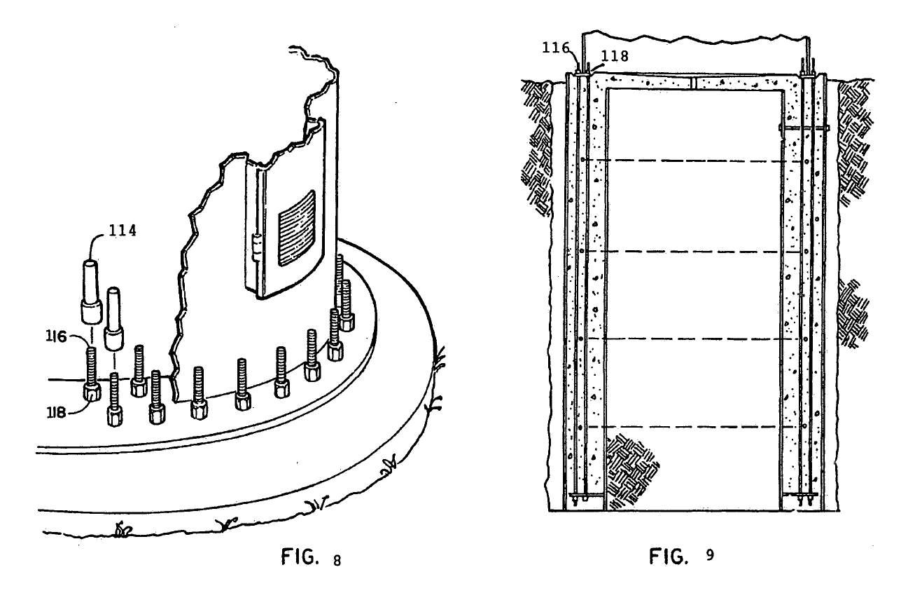

FIG. 8 is a typical installation using an anchor bolt and nut assembly, where 114 is a generic anchor bolt cap, 116 is an anchor bolt, and 118 is an anchor bolt nut.

FIG. 9 is a typical installation using an anchor bolt and nut assembly, where 116 is an anchor bolt and 118 is an anchor bolt nut.

The disclosed device is an anchor bolt cap 10 for placement over an anchor bolt and nut assembly that comprises an anchor bolt nut enclosure 12 with an anchor bolt nut enclosure bottom side 14 sized to fit over the anchor bolt nut and an anchor bolt nut enclosure top side 16 having an aperture sized to fit around of a portion of the anchor bolt. There is a tubular anchor bolt enclosure member 18 having an anchor bolt enclosure member bottom end 20 and an anchor bolt enclosure member top end 22. The tubular anchor bolt enclosure member bottom end 20 has a connection means adapted for connection to the anchor bolt nut enclosure top/side 16. There is an end cap 24 having an end cap top side 26, and an end cap open bottom side 30. The open bottom side 30 has a connection means adapted for connection to the tubular anchor bolt enclosure member top end 22. The anchor bolt nut enclosure bottom side 14 can further comprise a groove, and there can be an o-ring placed in the groove. The anchor bolt nut enclosure bottom side 14 can have an anchor bolt nut enclosure bottom flange member 32, and the anchor bolt nut enclosure bottom flange member 32 can have a groove. There can be an o-ring placed in the groove. The anchor bolt nut enclosure top side 16 can have a flange member 34 sized to encompass the diameter of the anchor bolt. The connection means can be thermal or chemical welding, or mating threads on the tubular anchor bolt enclosure member ends 20 and 22 that match threads on the anchor bolt nut enclosure top side 16 and the open bottom side 30.

In use, it can now be understood that the anchor bolts are placed into the earth, the flange placed atop the anchor bolts, a first series of nuts are placed onto the anchor bolts and threaded towards the flange and a second series of nuts are then placed onto the anchor bolts. The second series of nuts are used to place the lifting device against, and are thus used to pre-tension the anchor bolts. The first series of nuts are then lightly tightened against the flange and the lifting device is removed, resulting in the first series of nuts being tensioned against the flange.

The anchor bolt cap is then installed at the conclusion of the structure installation, to protect the anchor bolt from the elements. The anchor bolt cap is installed by placing a slide hammer around the tubular anchor bolt enclosure member and driving the hammer downward. The slide hammer impacts against the anchor bolt nut enclosure top side and thus places the anchor bolt cap onto the anchor bolt and nut assembly. Should the anchor bolt cap require removal to check for anchor bolt integrity, this can be accomplished in the reverse manner as the installation of the anchor bolt cap, by placing a slide hammer around the tubular anchor bolt enclosure member and driving the hammer upward to dislodge the anchor bolt cap. The slide hammer impacts against the end cap and thus frees the anchor bolt cap from the anchor bolt and nut assembly.

While the anchor bolt cap and method of use has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the disclosed device. For example, any suitable sturdy material such as metal or a form of plastic may be used to form the anchor bolt cap. Also, the anchor bolt cap may be installed and removed using a device other than a slide hammer. Furthermore, a wide variety of connection methods may be used instead of the described methods.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. An anchor bolt cap for placement over an anchor bolt and nut assembly comprising:
an anchor bolt nut enclosure having a bottom side sized to fit over the anchor bolt nut and a top side having an aperture sized to fit around a portion of the anchor bolt;
a tubular anchor bolt enclosure member having a bottom end and a top end wherein the distance between said bottom end and said top end is variable, said bottom end having a connection means adapted for connection to said anchor bolt nut enclosure top side; and
an end cap having a closed top side and an open bottom side, said open bottom side having a connection means adapted for connection to said tubular anchor bolt enclosure member top end.

2. The anchor bolt cap of claim 1 wherein said anchor bolt nut enclosure bottom side further comprises a groove.

3. The anchor bolt cap of claim 2 wherein an o-ring is placed in said groove.

4. The anchor bolt cap of claim 1 wherein said anchor bolt nut enclosure bottom side further comprises a bottom flange member.

5. The anchor bolt cap of claim 4 wherein said anchor bolt nut enclosure bottom flange member further comprises a groove.

6. The anchor bolt cap of claim 5 wherein an o-ring is placed in said groove.

7. The anchor bolt cap of claim 1 wherein said anchor bolt nut enclosure top side further comprises a flange member.

8. The anchor bolt cap of claim 1 wherein said connection means is thermal welding.

9. The anchor bolt cap of claim 1 wherein said connection means is chemical welding.

10. The anchor bolt cap of claim 1 wherein said connection means is mating threads.

11. An anchor bolt cap for placement over an anchor bolt and nut assembly comprising:
an anchor bolt nut enclosure having a bottom side sized to fit over the anchor bolt nut, said anchor bolt nut enclosure bottom side having a bottom flange member, and a top side having an aperture sized to fit around a portion of the anchor bolt, said top side having a flange member;
a tubular anchor bolt enclosure member having a bottom end and a top end wherein the distance between said bottom end and said top end is variable, said bottom end having a connection means adapted for connection to said anchor bolt nut enclosure top side; and
an end cap having a closed top side and an open bottom side, said open bottom side having a connection means adapted for connection to said tubular anchor bolt enclosure member top end.

12. The anchor bolt cap of claim 11 wherein said anchor bolt nut enclosure bottom flange member further comprises a groove.

13. The anchor bolt cap of claim 12 wherein an o-ring is placed in said groove.

14. The anchor bolt cap of claim 11 wherein said connection means is thermal welding.

15. The anchor bolt cap of claim 11 wherein said connection means is chemical welding.

16. The anchor bolt cap of claim 11 wherein said connection means is mating threads.

17. A method of using an anchor bolt cap for placement over an anchor bolt and nut assembly comprising:
determining the length of a tubular anchor bolt enclosure member, wherein said enclosure member has a first end and a second end;
cutting said tubular anchor bolt enclosure member to the determined size;
attaching said first end of said tubular anchor bolt enclosure member to an anchor bolt nut enclosure;
attaching said second end of said tubular anchor bolt enclosure member to an end cap; and
using a slide hammer to place said anchor bolt nut enclosure onto an anchor bolt nut.

18. The method of claim 17 further comprising:
using a slide hammer to remove said anchor bolt nut enclosure from said anchor bolt nut.
